(19) United States
(12) Patent Application Publication
(10) Pub. No.: US 2026/0265013 A1
(43) Pub. Date: Sep. 10, 2026

(54) CONVEYANCE PATH OPENING/CLOSING STRUCTURE OF MEDIA STORAGE UNIT

(71) Applicant: HYOSUNG TNS INC., Seoul (KR)

(72) Inventors: Tae Gang KIM, Gyeonggi-do (KR); Tai Woo LEE, Gyeonggi-do (KR); Chang Ho LEE, Gyeonggi-do (KR); Seung Jae OH, Gyeonggi-do (KR)

(21) Appl. No.: 19/124,650

(22) PCT Filed: Dec. 11, 2023
(86) PCT No.: PCT/KR2023/095104

§ 371 Date: May 6, 2026

(30) Foreign Application Priority Data
Dec. 29, 2022 (KR) 10-2022-0189659

(51) Int. Cl. B65H 29/00; G07D 11/13

(52) U.S. Cl. CPC B65H 29/00; G07D 11/13; B65H 2402/441; B65H 2402/45; B65H 2405/00; B65H 2515/60; G07D 2211/00

(57) ABSTRACT

One embodiment provides a conveyance path opening/closing structure of a media storage unit, the conveyance path opening/closing structure including a main body in which a media storage space is formed and a conveyance path provided on one side portion of the main body and along which media are conveyed, wherein the conveyance path includes a first conveyance path located inward from the main body and a second conveyance path located opposite to the first conveyance path and located outward from the main body, and rotation link parts guiding rotation of the second conveyance path to open/close the conveyance path are connected to one side end of the second conveyance path.

### BACKGROUND

### 1. Field of the Invention

The present invention relates to a conveyance path opening/closing structure of a media storage unit, and more particularly, to a conveyance path opening/closing structure of a media storage unit that can easily open or close a conveyance path without unlocking a locking device.

### 2. Discussion of Related Art

Generally, media storage units in which a media storage space is provided to store paper media such as cash or checks are provided in an automated teller machine.

When the media storage units are stacked in multiple stages, a conveyance path for conveying media to the media storage unit located at a lower side is also formed in the media storage unit located at an upper portion.

A conventional media storage unit has a problem that a task of maintenance and repair of a conveyance path is inconvenient due to a structure in which opening of the conveyance path for maintenance and repair of the conveyance path is only possible when a locking device is unlocked using a key.

In addition, the structure for opening/closing the conveyance path of the conventional media storage unit has a problem that a space for the maintenance and repair task is narrow and small due to a structure in which the conveyance path is rotatable only to a certain angle and only a portion of the conveyance path is openable, and there is a problem that a conveyance surface of the conveyance path is damaged due to being scratched by a counterpart during rotation for opening the conveyance path.

In addition, the conventional media storage unit has a problem that, due to a structure in which the inside of the conveyance path cannot be checked through visual inspection from the outside, it is difficult to identify whether maintenance and repair of the conveyance path is necessary.

The related art of a conveyance path opening/closing structure of a media storage unit is disclosed in Korean Patent Publication No. 10-2011-0031015.

### SUMMARY OF THE INVENTION

The present invention is directed to providing a conveyance path opening/closing structure of a media storage unit that can facilitate opening/closing of a conveyance path and prevent damage to the conveyance path when opening/closing the conveyance path.

According to an aspect of the present invention, there is provided a conveyance path opening/closing structure of a media storage unit, the conveyance path opening/closing structure comprising: a main body in which a media storage space is formed; and a conveyance path provided on one side portion of the main body and along which media are conveyed, wherein the conveyance path includes a first conveyance path located inward from the main body and a second conveyance path located opposite to the first conveyance path and located outward from the main body, and rotation link parts guiding rotation of the second conveyance path to open/close the conveyance path are connected to one side end of the second conveyance path.

The rotation link parts each include a fixing member mounted at a fixed position inside the main body, a first rotating shaft provided on one side end of the fixing member, a rotating member connected to one side end of the first rotating shaft and rotated about the first rotating shaft, and a second rotating shaft connected to the other side end of the rotating member and serving as a center of rotation of the second conveyance path; the rotation link parts are connected to both side portions of the second conveyance path; and the second rotating shafts are inserted into both side portions of the second conveyance path, and a second rotating shaft insertion hole in the shape of a long hole having a predetermined length is formed in the longitudinal direction of the second conveyance path.

During rotation of the second conveyance path, when the second rotating shaft moves to one side close to the main body within the second rotating shaft insertion hole, one side end of the second conveyance path is spaced from the first conveyance path, and the second conveyance path is able to rotate without interfering with the first conveyance path.

The pair of rotating members provided at both side portions of the second conveyance path are connected to each other by a connecting member and are integrally rotated.

A cover made of a transparent material is coupled to an outer side surface of the second conveyance path.

The conveyance path opening/closing structure, further comprising a door for opening/closing one side surface of the main body, wherein the conveyance path is provided on an inner side of the door.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is an external perspective view of a media storage unit according to the present invention;

FIG. 2 is a perspective view illustrating a state in which a cover provided on a door of the media storage unit is rotated a predetermined angle and a conveyance path is partially open according to the present invention;

FIG. 3 is a perspective view illustrating a state in which the cover provided on the door of the media storage unit is rotated a maximum angle and the conveyance path is completely open according to the present invention;

FIG. 4 is a perspective view showing a state in which a rotation link part is connected to a second conveyance path of the media storage unit according to the present invention;

FIG. 5 is an exploded perspective view of the second conveyance path and the rotation link part of the media storage unit according to the present invention; and

FIG. 6 is a view showing (a) a state in which a second rotating shaft of the rotation link part illustrated in FIG. 4 is located at the right side of a second rotating shaft insertion hole and (b) a state in which the second rotating shaft of the rotation link part illustrated in FIG. 4 is located at the left side of the second rotating shaft insertion hole.

### DESCRIPTION OF REFERENCE NUMERALS

| | |
|---|---|
| 1: media storage unit | 100: main body |
| 200: door | 210: hinge part |
| 220: locking device | 300: conveyance path |
| 300a: first conveyance path | 300b: second conveyance path |
| 301: second rotating shaft insertion hole (long hole) | 400: cover |
| 500: rotation link part | 510: fixing member |
| 511, 512: fastening member | 520: first rotating shaft |
| 530: rotating member | 540: second rotating shaft |
| 550: connecting member | |

### DETAILED DESCRIPTION OF EXEMPLARY EMBODIMENTS

Hereinafter, configurations and effects relating to exemplary embodiments of the present invention will be described in detail with reference to the accompanying drawings.

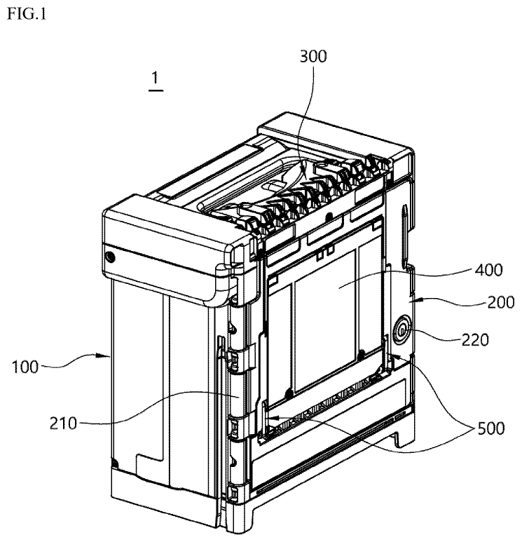

Referring to FIGS. 1 to 6, a media storage unit 1 of the present invention includes a main body 100, a door 200 opening/closing one side surface of the main body 100, a conveyance path 300 provided on one side portion of the main body 100 and along which media are conveyed, and a cover 400 covering an outer side surface of the conveyance path 300.

A media storage space in which media are stacked and stored is provided inside the main body 100.

The door 200 may rotate about a hinge part 210 at one side and open/close the one side surface of the main body 100, and a locking device 220 may be provided on the other side portion of the door 200.

The conveyance path 300 is provided on the one side portion of the main body 100 and provides a path along which media are conveyed, and the conveyance path 300 includes a first conveyance path 300a located inward from the main body 100 and a second conveyance path 300b located opposite to the first conveyance path 300a and located outward from the main body 100. The conveyance path 300 may be provided on an inner side of the door 200.

The second conveyance path 300b is configured to rotate to a front of the first conveyance path 300a to enable the conveyance path 300 to be opened/closed.

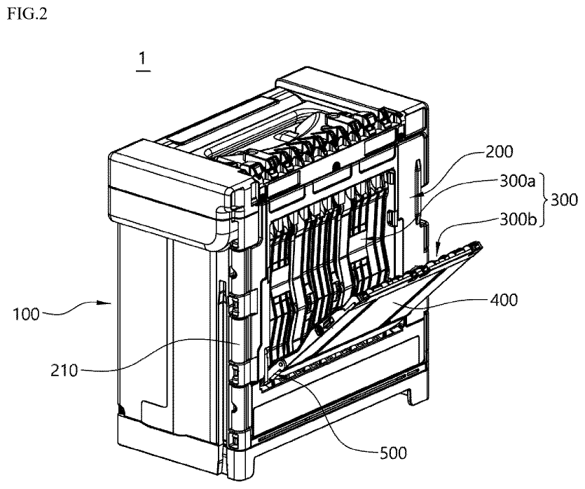

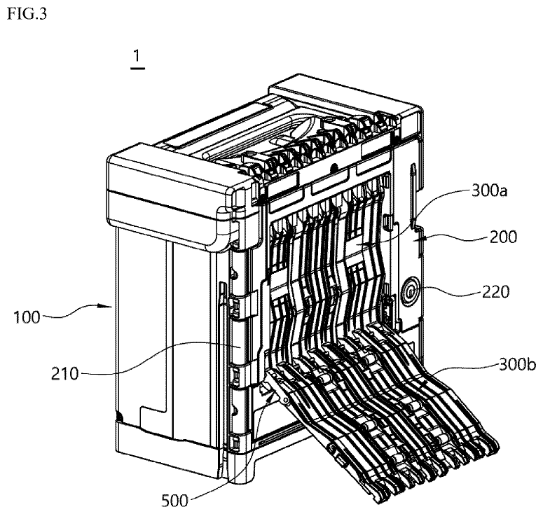

FIG. 1 illustrates a state in which the second conveyance path 300b is closed, FIG. 2 illustrates a state in which the second conveyance path 300b is rotated a predetermined angle, and FIG. 3 illustrates a state in which the second conveyance path 300b is completely rotated a maximum angle.

Rotation link parts 500 guiding rotation of the second conveyance path 300b to open/close the conveyance path 300 are connected to one side end of the second conveyance path 300b.

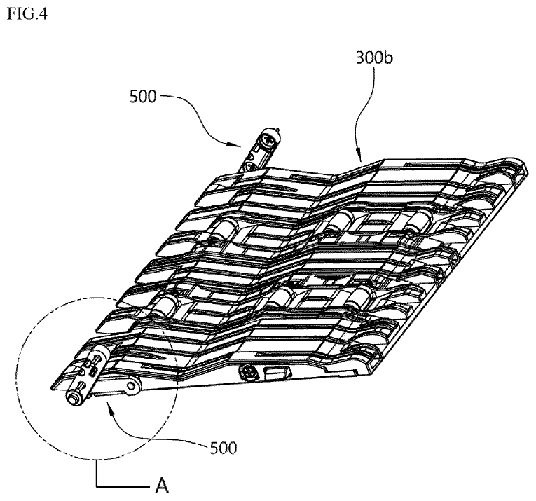

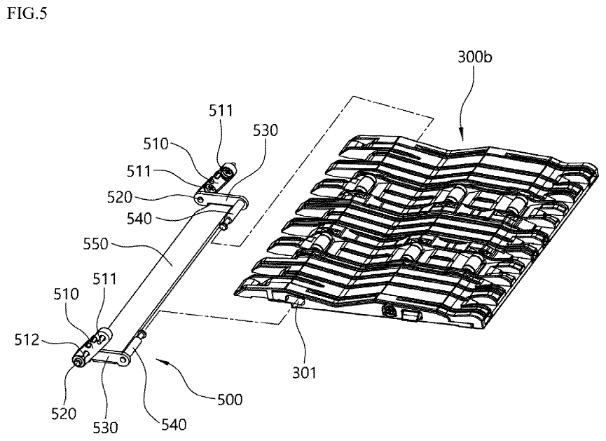

Referring to FIGS. 4 and 5, each rotation link part 500 includes a fixing member 510 mounted at a fixed position inside the main body 100, a first rotating shaft 520 provided on one side end of the fixing member 510, a rotating member 530 connected to one side end of the first rotating shaft 520 and rotated about the first rotating shaft 520, and a second rotating shaft 540 connected to the other side end of the rotating member 530 and serving as a center of rotation of the second conveyance path 300b.

The rotation link parts 500 are connected to both side portions of the second conveyance path 300b while symmetrical to each other.

In addition, the pair of rotating members 530 provided at both side portions of the second conveyance path 300b are connected to each other by a connecting member 550 and are integrally rotated. Accordingly, both side portions of the second conveyance path 300b may be smoothly rotated while stably supported by a pair of rotation link parts 500.

The second rotating shafts 540 are inserted into both side portions of the second conveyance path 300b, and a second rotating shaft insertion hole 301 in the shape of a long hole having a predetermined length is formed in the longitudinal direction of the second conveyance path 300b.

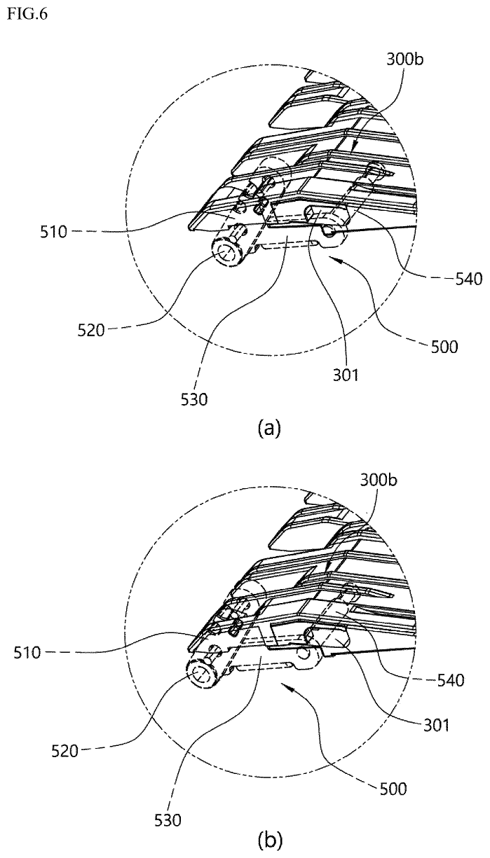

Referring to FIG. 6, during rotation of the second conveyance path 300b, when the second rotating shaft 540 moves to one side close to the main body 100 within the second rotating shaft insertion hole 301, that is, moves from state (a) of FIG. 6 to state (b) of FIG. 6, one side end of the second conveyance path 300b is spaced from the first conveyance path 300a.

Accordingly, since the second conveyance path 300b does not interfere with the first conveyance path 300a, damage due to scratching between the second conveyance path 300b and the first conveyance path 300a can be prevented during the rotation of the second conveyance path 300b, and since the second conveyance path 300b can rotate almost 180°, a wide space can be secured for maintenance and repair of the conveyance path 300.

Meanwhile, the cover 400 made of a transparent material may be coupled to an outer side surface of the second conveyance path 300b. By the cover 400 being made of a transparent material, an internal state of the conveyance path 300 can be easily checked through visual inspection from outside the media storage unit 1, and thus whether maintenance and repair are necessary can be easily identified.

In addition, according to the conveyance path opening/closing structure of the media storage unit according to the present invention, since it is possible to easily open/close the conveyance path 300 without unlocking the locking device 220, convenience of the task of maintenance and repair of the conveyance path 300 can be improved.

A conveyance path opening/closing structure of a media storage unit according to the present invention allows a conveyance path to be easily opened/closed without unlocking a locking device, and thus convenience of a task of maintenance and repair of the conveyance path can be improved.

In addition, a range in which a cover of the conveyance path is rotatable is increased to secure a wide space for the task, damage to the conveyance path is prevented during rotation of the cover, and thus opening/closing can be smoothly performed.

Further, the cover of the conveyance path is made of a transparent material to make it easy to check an internal state of the conveyance path through visual inspection from outside the media storage unit, and thus whether maintenance and repair are necessary can be easily identified.

The present invention is not limited to the embodiments described above, modifications are possible by those of ordinary skill in the art to which the invention pertains without departing from the technical spirit of the present invention claimed in the claims, and such modifications belong to the scope of the present invention.

What is claimed is:

1. A conveyance path opening/closing structure of a media storage unit, the conveyance path opening/closing structure comprising:
a main body in which a media storage space is formed; and
a conveyance path provided on one side portion of the main body and along which media are conveyed,
wherein the conveyance path includes a first conveyance path located inward from the main body and a second conveyance path located opposite to the first conveyance path and located outward from the main body, and
rotation link parts guiding rotation of the second conveyance path to open/close the conveyance path are connected to one side end of the second conveyance path.

2. The conveyance path opening/closing structure of claim 1, wherein:
the rotation link parts each include a fixing member mounted at a fixed position inside the main body, a first rotating shaft provided on one side end of the fixing member, a rotating member connected to one side end of the first rotating shaft and rotated about the first rotating shaft, and a second rotating shaft connected to the other side end of the rotating member and serving as a center of rotation of the second conveyance path;
the rotation link parts are connected to both side portions of the second conveyance path; and
the second rotating shafts are inserted into both side portions of the second conveyance path, and a second rotating shaft insertion hole in the shape of a long hole having a predetermined length is formed in the longitudinal direction of the second conveyance path.

3. The conveyance path opening/closing structure of claim 2, wherein, during rotation of the second conveyance path, when the second rotating shaft moves to one side close to the main body within the second rotating shaft insertion hole, one side end of the second conveyance path is spaced from the first conveyance path, and the second conveyance path is able to rotate without interfering with the first conveyance path.

4. The conveyance path opening/closing structure of claim 2, wherein the pair of rotating members provided at both side portions of the second conveyance path are connected to each other by a connecting member and are integrally rotated.

5. The conveyance path opening/closing structure of claim 1, wherein a cover made of a transparent material is coupled to an outer side surface of the second conveyance path.

6. The conveyance path opening/closing structure of claim 1, further comprising a door for opening/closing one side surface of the main body,
wherein the conveyance path is provided on an inner side of the door.
